(19) United States
(12) Patent Application Publication
(10) Pub. No.: US 2025/0131291 A1
(43) Pub. Date: Apr. 24, 2025

(54) SYSTEM AND METHOD FOR SCHEDULING OF USERs ACTIVITIES WITH ROBOT COMPUTING DEVICE OR DIGITAL COMPANION

(71) Applicant: Embodied, Inc., Pasadena, CA (US)

(72) Inventors: Vazgen Karapetyan, Northridge, CA (US); Mario Munich, La Canada, CA (US); Paolo Pirjanian, Glendale, CA (US); Grant Mitchell, Los Angeles, CA (US); Dave Benson, Altadena, CA (US); Wilson Harron, Los Angeles, CA (US); Justin Beghtol, Santa Ana, CA (US)

(21) Appl. No.: 18/382,789

(22) Filed: Oct. 23, 2023

(51) Int. Cl. G06N 5/022; A63H 3/00; G09B 5/06

(52) U.S. Cl. CPC G06N 5/022; A63H 3/003; A63H 2200/00; G09B 5/06

(57) ABSTRACT

A method to generate a list of recommended content modules for interactions between a robot computing device and a user includes receiving an instruction or command to create a list of recommended content modules for a robot computing device to engage with a user of the robot computing device; receiving a list of available content modules and associated identifiers (IDs), receiving a list of additional available content modules and associated identifiers (IDs); receiving one or more preference parameters, the one or more preference parameters include topic preference parameters, activity preference parameters, and skill preference parameters; receiving a list of completed content modules and associated identifiers (IDs) for the user that the user has engaged in with the robot computing device; and receiving module selection constraint parameters to identify limitations as to what content modules may be included in the list of recommended content modules.

### BACKGROUND

Conversational robots are purchased to be utilized with subjects and engage in activities such as conversations, games, book readings, and/or missions. However, no conversational robots lack any schedule of activities. Accordingly, a need exists for conversational robots to have a system and method for scheduling of user or subject's activities.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1A illustrates for a system for a social or conversational robot, digital companion or robot computing device to engage with and/or communicate with a parent according to some embodiments;

FIG. 1B illustrates an outline of a conversation robot or robot computing device according to some embodiments;

FIG. 1C illustrates a block diagram of subsystems and/or software modules for a social robot, digital companion or robot computing device to engage a child and/or a parent;

FIG. 2 is a diagram depicting system architecture of robot computing device or robot (e.g., 105 of FIG. 1B), according to implementations;

FIG. 3 illustrates a robot computing device that may be utilized for multiple users according to some implementations;

FIG. 4A is a block diagram of modules included in a robot computing device system that includes an automatic activity scheduling method or process for users or subjects according to exemplary embodiments;

FIG. 4B is a block diagram of modules included in a robot computing device system that includes an automatic activity scheduling method or process or children according to specific embodiments;

FIG. 5A is a flowchart of an automatic scheduling method or process according to exemplary embodiments;

FIG. 5B illustrates a mentor's interests screen in the parent application according to some embodiments;

FIG. 5C illustrates a user's SEL Skills Development Input Screen according to exemplary embodiments;

FIG. 5D illustrates an Activity Preferences Input Screen according to exemplary embodiments;

FIG. 5E illustrates an Interaction Style and Accessibility input screen according to some implementations; and

FIG. 6 is a flowchart of a process for creating and receiving an activity schedule for an individual, subject or user according to exemplary embodiments.

### DETAILED DESCRIPTION

The following detailed description and provides a better understanding of the features and advantages of the inventions described in the present disclosure in accordance with the embodiments disclosed herein. The following detailed description describes a method and system that allows a resource owner to setup accounts and/or collect information for multiple users (who may be patients and/or students) who are using the same robot computing device and may create individual content progression for each user.

The following detailed description further describes a method and system that stores collected information from interactions between the Moxie Robot and multiple users in separate accounts in a safe and secure manner, which allows the robot to automatically adapt a curriculum or learning path better suited to the needs of each individual user. In other words, personalize a robot computing device's interaction for each user.

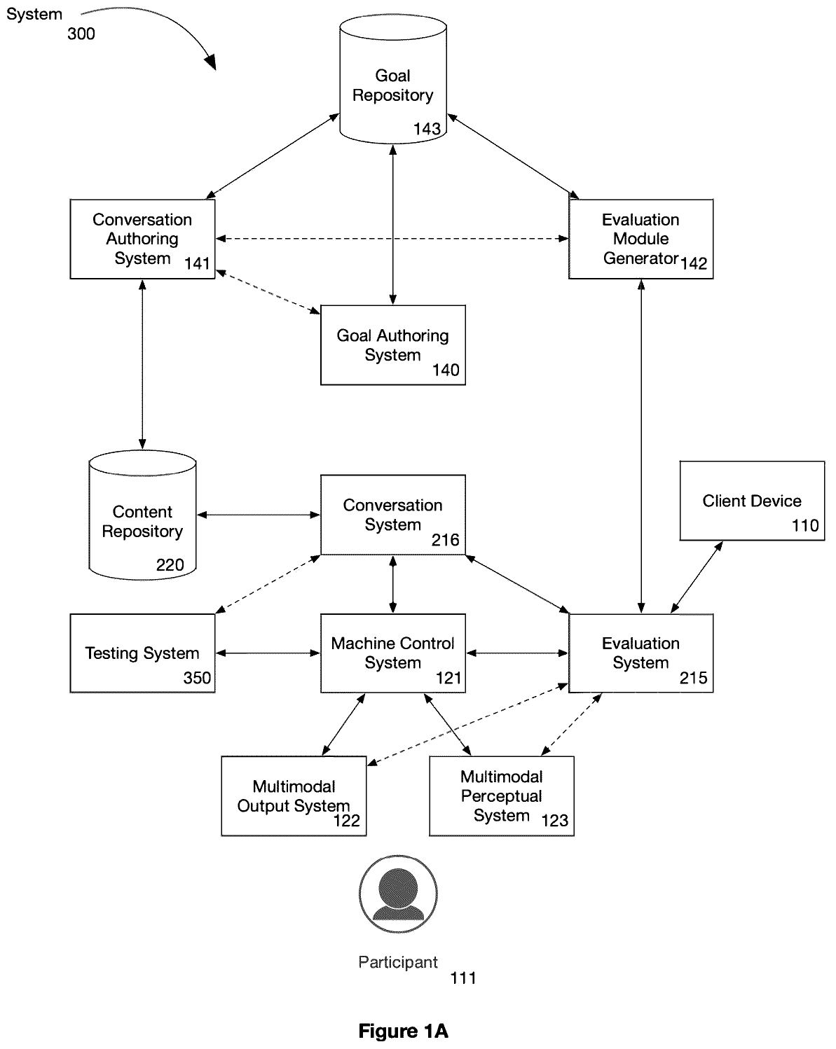

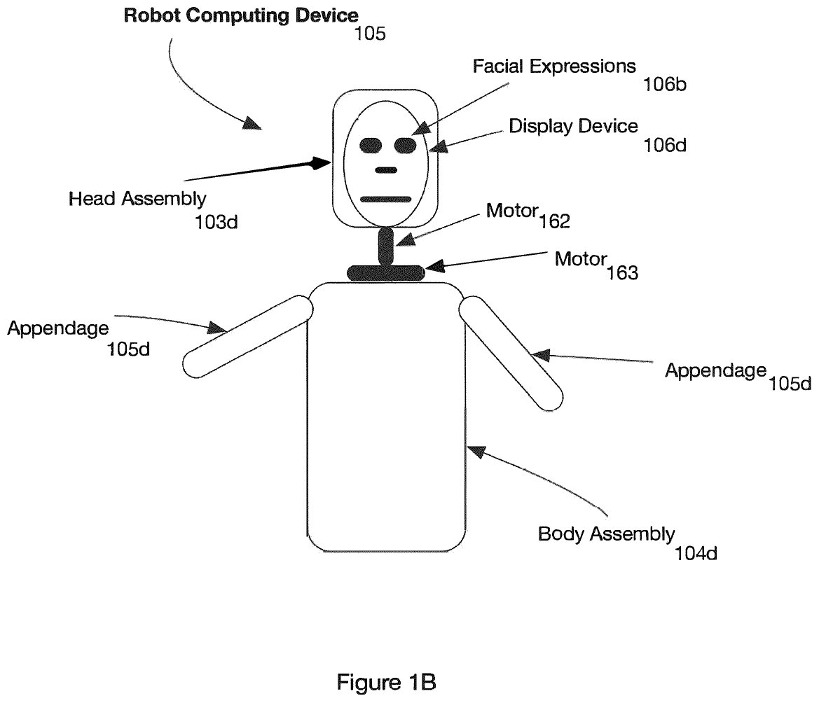

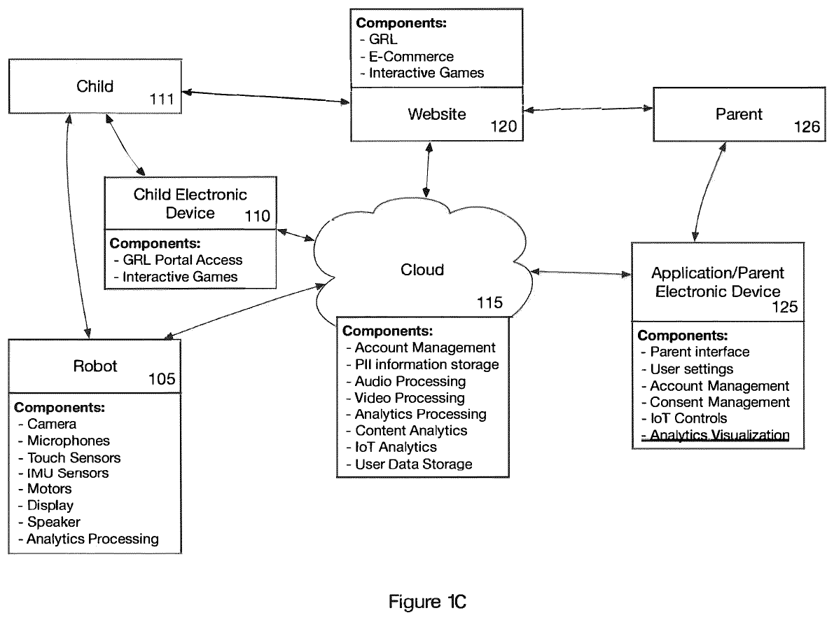

FIG. 1A illustrates a system for a social or conversational robot, digital companion or robot computing device to engage with and/or communicate with a parent according to some embodiments. FIG. 1B illustrates an outline of a conversation robot or robot computing device according to some embodiments. FIG. 1C illustrates a block diagram of subsystems and/or software modules for a social robot, digital companion or robot computing device to engage a child and/or a parent. In some implementations, a robot computing device 105 (or digital companion) may engage with a child 111 and establish communication interactions with the child 111. In some implementations, there will be bidirectional communication between the robot computing device 105 and the child 111 with a goal of establishing multi-turn conversations (e.g., both parties taking conversation turns) in the communication interactions. In some implementations, the robot computing device 105 may communicate with the child 111 via spoken words (e.g., audio actions,), visual actions (movement of eyes or facial expressions on a display screen), and/or physical actions (e.g., movement of a neck or head or an appendage of a robot computing device). In some implementations, the robot computing device 105 may utilize one or more imaging devices or cameras to evaluate a child's body language, a child's facial expressions and may utilize speech recognition software to evaluate and analyze the child's speech.

In some implementations, the child 111 may also have one or more associated electronic devices or computing devices 110. In some implementations, the one or more electronic devices 110 may allow a child to login to a website on a server computing device in order to access a learning laboratory and/or to engage in interactive games that are housed on the web site 120. In some implementations, the child's one or more computing devices 110 may communicate with cloud computing devices 115 in order to access the website 120. In alternative embodiments, the child's computing device 110 may communicate with the robot computing device 105 and/or also communicate with a server computing device 120 which houses interactive games and/or a learning library.

In some implementations, the website 120 may be housed on server computing devices. In some implementations, the website 120 may include the learning laboratory (which may be referred to as a global robotics laboratory (GRL) where a child can interact with digital characters or personas that are associated with the robot computing device 105. In some implementations, the website 120 may include interactive games where the child can engage in competitions or goal setting exercises. In some implementations, there may be other server or cloud computing devices which host a robot computing device manufacturer e-commerce website. The robot computing device does not communicate with the e-commerce website. In some implementation, other users may be able to interface with an e-commerce website or program, where the other users (e.g., parents or guardians) may purchases items that are associated with the robot (e.g., comic books, toys, badges or other affiliate items).

In some implementations, the system may include a parent computing device 125. In some implementations, the parent computing device 125 may include one or more processors and/or one or more memory devices. In some implementations, computer-readable instructions may be executable by the one or more processors to cause the parent computing device 125 to perform a number of features and/or functions. In some implementations, these features and functions may include generating and running a parent interface for the system. In some implementations, the software executable by the parent computing device 125 may also alter user (e.g., child, parent or guardian) settings. In some implementations, the software executable by the parent computing device 125 may also allow the parent or guardian to manage their own account or their child's account in the system. In some implementations, the software application may be referred to as a parent application or a parent app. In some implementations, the software executable by the parent computing device 125 may allow the parent or guardian to initiate or complete parental consent to allow certain features of the robot computing device to be utilized. In some implementations, the software executable by the parent computing device 125 may allow a parent or guardian to set goals or thresholds or settings what is captured from the robot computing device and what is analyzed and/or utilized by the system. In some implementations, the software executable by the one or more processors of the parent computing device 125 may allow the parent or guardian to view the different analytics generated by the system in order to see how the robot computing device is operating, how their child is progressing against established goals, and/or how the child is interacting with the robot computing device. In some implementations, although the parent application is installed on the parent computing device, some functions of the software may be stored in a cloud computing device which interfaces with the parent application.

In some implementations, the system may include a cloud server computing device 115. In some implementations, the cloud server computing device 115 may include one or more processors and one or more memory devices. In some implementations, computer-readable instructions may be retrieved from the one or more memory devices and executable by the one or more processors to cause the cloud server computing device 115 to perform calculations and/or additional functions. In some implementations, the software (e.g., the computer-readable instructions executable by the one or more processors) may manage accounts for all the users (e.g., the child, the parent and/or the guardian). In some implementations, the software may also manage the storage of personally identifiable information in the one or more memory devices of the cloud server computing device 115. In some implementations, the software may also execute the audio processing (e.g., speech recognition and/or context recognition) of sound files that are captured from the child, parent or guardian, as well as generating speech and related audio file that may be spoken by the robot computing device 115. In some implementations, the software in the cloud server computing device 115 may perform and/or manage the video processing of images that are received from the robot computing devices and/or the creation of facial expression datapoints. In some implementations, the software in the cloud server computing device 115 may analyze images provided from the robot computing devices to identify a primary user of the robot computing device 105.

In some implementations, the software of the cloud server computing device 115 may analyze received inputs from the various sensors and/or other input modalities as well as gather information from other software applications as to the child's progress towards achieving set goals. In some implementations, the cloud server computing device 115 software may be executable by the one or more processors in order perform analytics processing. In some implementations, analytics processing may be behavior analysis on how well the child is doing with respect to established goals.

In some implementations, the software of the cloud server computing device 115 may receive input regarding how the user or child is responding to content, for example, does the child like the story, the augmented content, and/or the output being generated by the one or more output modalities of the robot computing device 105. In some implementations, the cloud server computing device 115 may receive the input regarding the child's response to the content and may perform analytics on how well the content is working and whether or not certain portions of the content may not be working (e.g., perceived as boring or potentially malfunctioning or not working).

In some implementations, the software of the cloud server computing device 115 may receive inputs such as parameters or measurements from hardware components of the robot computing device 105 such as the sensors, the batteries, the motors, the display and/or other components. In some implementations, the software of the cloud server computing device 115 may receive the parameters and/or measurements from the hardware components and may perform IOT Analytics processing on the received parameters, measurements or data to determine if the robot computing device 105 is malfunctioning and/or not operating at an optimal manner.

In some implementations, the cloud server computing device 115 may include one or more memory devices. In some implementations, portions of the one or more memory devices may store user data for the various account holders. In some implementations, the user data may be user address, user goals, user details and/or preferences. In some implementations, the user data may be encrypted and/or the storage may be a secure and/or encrypted storage.

FIG. 1C illustrates functional modules of a system including a robot computing device according to some implementations. In some embodiments, at least one method described herein is performed by a system 300 that includes the conversation system 216, a machine control system 121, a multimodal output system 122, a multimodal perceptual system 123, a testing system 350, and/or an evaluation system 215. In some implementations, at least one of the conversation system 216, a machine control system 121, a multimodal output system 122, a multimodal perceptual system 123, a testing system 350, and/or an evaluation system 215 may be included in a robot computing device or a machine. In some embodiments, the machine is a robot, a robot computing device, a digital companion, and/or computing devices that have facial recognition software, gesture analysis software, speech recognition software, and/or sound recognition software. In the specification, terms such as robot computing device, robot, machine, and/or digital companion may be utilized interchangeably. In the specification, terms such as conversation engine, conversation system, conversation module and/or conversation agent may be utilized interchangeably.

In some implementations, the conversation system 216 may be communicatively coupled a control system 121 of the machine. In some embodiments, the conversation system may be communicatively coupled to the evaluation system 215. In some implementations, the conversation system 216 may be communicatively coupled to a conversational content repository 220. In some implementations, the conversation system 216 may be communicatively coupled to a conversation testing system 350. In some implementations, the conversation system 216 may be communicatively coupled to a conversation authoring system 141. In some implementations, the conversation system 216 may be communicatively coupled to a goal authoring system 140. In some implementations, the conversation system 216 may be a cloud-based conversation system provided by a conversation system server that is communicatively coupled to the control system 121 via the Internet or other global communications network. In some implementations, the conversation system 216 may be the Embodied Chat Operating System.

In some implementations, the conversation system 216 may be an embedded conversation system that is included in the robot computing device or implementations. In some implementations, the control system 121 may be constructed to control a multimodal output system 122 and a multimodal perceptual system 123 that includes at least one sensor. In some implementations, the control system 121 may be constructed to interact with the conversation system 216. In some implementations, the machine or robot computing device may include the multimodal output system 122. In some implementations, the multimodal output system 122 may include at least one of an audio output sub-system, a video display sub-system, a mechanical robotic subsystem, a light emission sub-system, a LED (Light Emitting Diode) ring, and/or a LED (Light Emitting Diode) array. In some implementations, the machine or robot computing device may include the multimodal perceptual system 123, wherein the multimodal perceptual system 123 may include the at least one sensor. In some implementations, the multimodal perceptual system 123 includes at least one of a sensor of a heat detection sub-system, a sensor of a video capture sub-system, a sensor of an audio capture sub-system, a touch sensor, a piezoelectric pressor sensor, a capacitive touch sensor, a resistive touch sensor, a blood pressure sensor, a heart rate sensor, and/or a biometric sensor. In some implementations, the multimodal perceptual system 123 may include one or more microphones and/or one or more cameras or imaging devices. In some implementations, the evaluation system 215 may be communicatively coupled to the control system 121. In some implementations, the evaluation system 130 may be communicatively coupled to the multimodal output system 122. In some implementations, the evaluation system 215 may be communicatively coupled to the multimodal perceptual system 123. In some implementations, the evaluation system 215 may be communicatively coupled to the conversation system 216. In some implementations, the evaluation system 215 may be communicatively coupled to a client device 110 (e.g., a parent or guardian's mobile device or computing device). In some implementations, the evaluation system 215 may be communicatively coupled to the goal authoring system 140. In some implementations, the evaluation system 215 may include computer-readable-instructions of a goal evaluation module that, when executed by the evaluation system, may control the evaluation system 215 to process information generated from the multimodal perceptual system 123 to evaluate a goal associated with conversational content processed by the conversation system 216. In some implementations, the goal evaluation module is generated based on information provided by the goal authoring system 140.

In some implementations, the goal evaluation module 215 may be generated based on information provided by the conversation authoring system 141. In some embodiments, the goal evaluation module 215 may be generated by an evaluation module generator 142. In some implementations, the conversation testing system may receive user input from a test operator and may provide the control system 121 with multimodal output instructions (either directly or via the conversation system 216). In some implementations, the conversation testing system 350 may receive event information indicating a human response sensed by the machine or robot computing device (either directly from the control system 121 or via the conversation system 216). In some implementations, the conversation authoring system 141 may be constructed to generate conversational content and store the conversational content in one of the content repository 220 or the conversation system 216. In some implementations, responsive to updating of content currently used by the conversation system 216, the conversation system may be constructed to store the updated content at the content repository 220.

In some embodiments, the goal authoring system 140 may be constructed to generate goal definition information that is used to generate conversational content. In some implementations, the goal authoring system 140 may be constructed to store the generated goal definition information in a goal repository 143. In some implementations, the goal authoring system 140 may be constructed to provide the goal definition information to the conversation authoring system 141. In some implementations, the goal authoring system 143 may provide a goal definition user interface to a client device that includes fields for receiving user-provided goal definition information. In some embodiments, the goal definition information specifies a goal evaluation module that is to be used to evaluate the goal. In some implementations, each goal evaluation module is at least one of a sub-system of the evaluation system 215 and a sub-system of the multimodal perceptual system 123. In some embodiments, each goal evaluation module uses at least one of a sub-system of the evaluation system 215 and a sub-system of the multimodal perceptual system 123. In some implementations, the goal authoring system 140 may be constructed to determine available goal evaluation modules by communicating with the machine or robot computing device, and update the goal definition user interface to display the determined available goal evaluation modules.

In some implementations, the goal definition information defines goal levels for goal. In some embodiments, the goal authoring system 140 defines the goal levels based on information received from the client device (e.g., user-entered data provided via the goal definition user interface). In some embodiments, the goal authoring system 140 automatically defines the goal levels based on a template. In some embodiments, the goal authoring system 140 automatically defines the goal levels based on information provided by the goal repository 143, which stores information of goal levels defined form similar goals. In some implementations, the goal definition information defines participant support levels for a goal level. In some embodiments, the goal authoring system 140 defines the participant support levels based on information received from the client device (e.g., user-entered data provided via the goal definition user interface). In some implementations, the goal authoring system 140 may automatically define the participant support levels based on a template. In some embodiments, the goal authoring system 140 may automatically define the participant support levels based on information provided by the goal repository 143, which stores information of participant support levels defined form similar goal levels. In some implementations, conversational content includes goal information indicating that a specific goal should be evaluated, and the conversational system 216 may provide an instruction to the evaluation system 215 (either directly or via the control system 121) to enable the associated goal evaluation module at the evaluation system 215. In a case where the goal evaluation module is enabled, the evaluation system 215 executes the instructions of the goal evaluation module to process information generated from the multimodal perceptual system 123 and generate evaluation information. In some implementations, the evaluation system 215 provides generated evaluation information to the conversation system 215 (either directly or via the control system 121). In some implementations, the evaluation system 215 may update the current conversational content at the conversation system 216 or may select new conversational content at the conversation system 100 (either directly or via the control system 121), based on the evaluation information.

FIG. 1B illustrates a robot computing device according to some implementations. In some implementations, the robot computing device 105 may be a machine, a robot, a digital companion, an electro-mechanical device including computing devices. These terms may be utilized interchangeably in the specification. In some implementations, as shown in FIG. 1B, the robot computing device 105 may include a head assembly 103d, a display device 106d, at least one mechanical appendage 105d (two are shown in FIG. 1B), a body assembly 104d, a vertical axis rotation motor 163, and/or a horizontal axis rotation motor 162. In some implementations, the robot computing device may include a multimodal output system 122 and the multimodal perceptual system 123. In some implementations, the display device 106d may allow facial expressions 106b to be shown or illustrated after being generated. In some implementations, the facial expressions 106b may be shown by the two or more digital eyes, a digital nose and/or a digital mouth. In some implementations, other images or parts may be utilized to show facial expressions. In some implementations, the horizontal axis rotation motor 163 may allow the head assembly 103d to move from side-to-side which allows the head assembly 103d to mimic human neck movement like shaking a human's head from side-to-side. In some implementations, the vertical axis rotation motor 162 may allow the head assembly 103d to move in an up-and-down direction like shaking a human's head up and down. In some implementations, an additional motor may be utilized to move the robot computing device (e.g., the entire robot or computing device) to a new position or geographic location in a room or space (or even another room). In this implementation, the additional motor may be connected to a drive system that causes wheels, tires or treads to rotate and thus physically move the robot computing device.

In some implementations, the body assembly 104d may include one or more touch sensors. In some implementations, the body assembly's touch sensor(s) may allow the robot computing device to determine if it is being touched or hugged. In some implementations, the one or more appendages 105d may have one or more touch sensors. In some implementations, some of the one or more touch sensors may be located at an end of the appendages 105d (which may represent the hands). In some implementations, this allows the robot computing device 105 to determine if a user or child is touching the end of the appendage (which may represent the user shaking the user's hand).

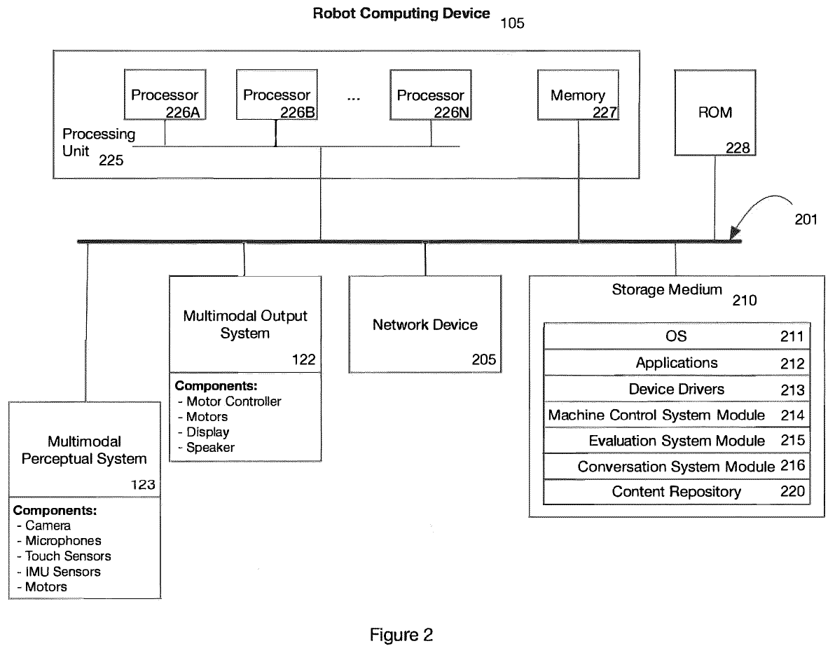

FIG. 2 is a diagram depicting system architecture of robot computing device or robot (e.g., 105 of FIG. 1B), according to implementations. In some implementations, the robot computing device or system of FIG. 2 may be implemented as a single hardware device. In some implementations, the robot computing device and system of FIG. 2 may be implemented as a plurality of hardware devices. In some implementations, the robot computing device and system of FIG. 2 may be implemented as an ASIC (Application-Specific Integrated Circuit). In some implementations, the robot computing device and system of FIG. 2 may be implemented as an FPGA (Field-Programmable Gate Array). In some implementations, the robot computing device and system of FIG. 2 may be implemented as a SoC (System-on-Chip). In some implementations, the bus 201 may interface with the processors 226A-N, the main memory 227 (e.g., a random access memory (RAM)), a read only memory (ROM) 228, one or more processor-readable storage mediums 210, and one or more network device 211. In some implementations, bus 201 interfaces with at least one of a display device (e.g., 102c) and a user input device. In some implementations, bus 101 interfaces with the multi-modal output system 122. In some implementations, the multi-modal output system 122 may include an audio output controller. In some implementations, the multi-modal output system 122 may include a speaker. In some implementations, the multi-modal output system 122 may include a display system or monitor. In some implementations, the multi-modal output system 122 may include a motor controller. In some implementations, the motor controller may be constructed to control the one or more appendages (e.g., 105d) of the robot system of FIG. 1B. In some implementations, the motor controller may be constructed to control a motor of an appendage (e.g., 105d) of the robot system of FIG. 1B. In some implementations, the motor controller may be constructed to control a motor (e.g., a motor of a motorized, a mechanical robot appendage).

In some implementations, a bus 201 may interface with the multi-modal perceptual system 123 (which may be referred to as a multi-modal input system or multi-modal input modalities. In some implementations, the multi-modal perceptual system 123 may include one or more audio input processors. In some implementations, the multi-modal perceptual system 123 may include a human reaction detection sub-system. In some implementations, the multimodal perceptual system 123 may include one or more microphones. In some implementations, the multimodal perceptual system 123 may include one or more camera(s) or imaging devices.

In some implementations, at least one of a central processing unit (processor), a GPU, and a multi-processor unit (MPU) may be included. In some implementations, the processors and the main memory form a processing unit 225. In some implementations, the processing unit 225 includes one or more processors communicatively coupled to one or more of a RAM, ROM, and computer-readable storage medium; the one or more processors of the processing unit receive instructions stored by the one or more of a RAM, ROM, and computer-readable storage medium via a bus; and the one or more processors execute the received instructions. In some implementations, the processing unit is an ASIC (Application-Specific Integrated Circuit). In some implementations, the processing unit may be a SoC (System-on-Chip). In some implementations, the processing unit may include at least one arithmetic logic unit (ALU) that supports a SIMD (Single Instruction Multiple Data) system that provides native support for multiply and accumulate operations. In some implementations the processing unit is a Central Processing Unit such as an Intel Xeon processor. In other implementations, the processing unit includes a Graphical Processing Unit such as NVIDIA Tesla.

In some implementations, the one or more network adapter devices or network interface devices 205 may provide one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like. In some implementations, the one or more network adapter devices or network interface devices 205 may be wireless communication devices. In some implementations, the one or more network adapter devices or network interface devices 205 may include personal area network (PAN) transceivers, wide area network communication transceivers and/or cellular communication transceivers. In some implementations, the one or more network adapter devices or network interface devices 205 may provide one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like. In some implementations, the one or more network adapter devices or network interface devices 205 may be wireless communication devices. In some implementations, the one or more network adapter devices or network interface devices 205 may include personal area network (PAN) transceivers, wide area network communication transceivers and/or cellular communication transceivers.

In some implementations, the one or more network devices 205 may be communicatively coupled to another robot computing device (e.g., a robot computing device similar to the robot computing device 105 of FIG. 1B). In some implementations, the one or more network devices 205 may be communicatively coupled to an evaluation system module (e.g., 215). In some implementations, the one or more network devices 205 may be communicatively coupled to a conversation system module (e.g., 110). In some implementations, the one or more network devices 205 may be communicatively coupled to a testing system. In some implementations, the one or more network devices 205 may be communicatively coupled to a content repository (e.g., 220). In some implementations, the one or more network devices 205 may be communicatively coupled to a client computing device (e.g., 110). In some implementations, the one or more network devices 205 may be communicatively coupled to a conversation authoring system (e.g., 160). In some implementations, the one or more network devices 205 may be communicatively coupled to an evaluation module generator. In some implementations, the one or more network devices may be communicatively coupled to a goal authoring system. In some implementations, the one or more network devices 205 may be communicatively coupled to a goal repository. In some implementations, computer-executable instructions in software programs (such as an operating system 211, application programs 212, and device drivers 213) may be loaded into the one or more memory devices (of the processing unit) from the processor-readable storage medium, the ROM or any other storage location. During execution of these software programs, the respective computer-executable instructions may be accessed by at least one of processors 226A-226N (of the processing unit) via the bus 201, and then may be executed by at least one of processors. Data used by the software programs may also be stored in the one or more memory devices, and such data is accessed by at least one of one or more processors 226A-226N during execution of the computer-executable instructions of the software programs.

In some implementations, the processor-readable storage medium 210 may be one of (or a combination of two or more of) a hard drive, a flash drive, a DVD, a CD, an optical disk, a floppy disk, a flash storage, a solid-state drive, a ROM, an EEPROM, an electronic circuit, a semiconductor memory device, and the like. In some implementations, the processor-readable storage medium 210 may include computer-executable instructions (and related data) for an operating system 211, software programs or application software 212, device drivers 213, and computer-executable instructions for one or more of the processors 226A-226N of FIG. 2.

In some implementations, the processor-readable storage medium 210 may include a machine control system module 214 that includes computer-executable instructions for controlling the robot computing device to perform processes performed by the machine control system, such as moving the head assembly of robot computing device.

In some implementations, the processor-readable storage medium 210 may include an evaluation system module 215 that includes computer-executable instructions for controlling the robotic computing device to perform processes performed by the evaluation system. In some implementations, the processor-readable storage medium 210 may include a conversation system module 216 that may include computer-executable instructions for controlling the robot computing device 105 to perform processes performed by the conversation system. In some implementations, the processor-readable storage medium 210 may include computer-executable instructions for controlling the robot computing device 105 to perform processes performed by the testing system. In some implementations, the processor-readable storage medium 210, computer-executable instructions for controlling the robot computing device 105 to perform processes performed by the conversation authoring system.

In some implementations, the processor-readable storage medium 210, computer-executable instructions for controlling the robot computing device 105 to perform processes performed by the goal authoring system. In some implementations, the processor-readable storage medium 210 may include computer-executable instructions for controlling the robot computing device 105 to perform processes performed by the evaluation module generator.

In some implementations, the processor-readable storage medium 210 may include the content repository 220. In some implementations, the processor-readable storage medium 210 may include the goal repository 143. In some implementations, the processor-readable storage medium 210 may include computer-executable instructions for an emotion detection module. In some implementations, emotion detection module may be constructed to detect an emotion based on captured image data (e.g., image data captured by the perceptual system 123 and/or one of the imaging devices). In some implementations, the emotion detection module may be constructed to detect an emotion based on captured audio data (e.g., audio data captured by the perceptual system 123 and/or one of the microphones). In some implementations, the emotion detection module may be constructed to detect an emotion based on captured image data and captured audio data. In some implementations, emotions detectable by the emotion detection module include anger, contempt, disgust, fear, happiness, neutral, sadness, and surprise. In some implementations, emotions detectable by the emotion detection module include happy, sad, angry, confused, disgusted, surprised, calm, unknown. In some implementations, the emotion detection module is constructed to classify detected emotions as either positive, negative, or neutral. In some implementations, the robot computing device 105 may utilize the emotion detection module to obtain, calculate or generate a determined emotion classification (e.g., positive, neutral, negative) after performance of an action by the machine, and store the determined emotion classification in association with the performed action (e.g., in the storage medium 210).

In some implementations, the testing system 350 may a hardware device or computing device separate from the robot computing device, and the testing system includes at least one processor, a memory, a ROM, a network device, and a storage medium (constructed in accordance with a system architecture similar to a system architecture described herein for the machine 120), wherein the storage medium stores computer-executable instructions for controlling the testing system 350 to perform processes performed by the testing system, as described herein.

In some implementations, the conversation authoring system may be a hardware device separate from the robot computing device 105, and the conversation authoring system may include at least one processor, a memory, a ROM, a network device, and a storage medium (constructed in accordance with a system architecture similar to a system architecture described herein for the robot computing device 105), wherein the storage medium stores computer-executable instructions for controlling the conversation authoring system to perform processes performed by the conversation authoring system.

In some implementations, the evaluation module generator may be a hardware device separate from the robot computing device 105, and the evaluation module generator may include at least one processor, a memory, a ROM, a network device, and a storage medium (constructed in accordance with a system architecture similar to a system architecture described herein for the robot computing device), wherein the storage medium stores computer-executable instructions for controlling the evaluation module generator to perform processes performed by the evaluation module generator, as described herein.

In some implementations, the goal authoring system may be a hardware device separate from the robot computing device, and the goal authoring system may include at least one processor, a memory, a ROM, a network device, and a storage medium (constructed in accordance with a system architecture similar to a system architecture described instructions for controlling the goal authoring system to perform processes performed by the goal authoring system. In some implementations, the storage medium of the goal authoring system may include data, settings and/or parameters of the goal definition user interface described herein. In some implementations, the storage medium of the goal authoring system may include computer-executable instructions of the goal definition user interface described herein (e.g., the user interface). In some implementations, the storage medium of the goal authoring system may include data of the goal definition information described herein (e.g., the goal definition information). In some implementations, the storage medium of the goal authoring system may include computer-executable instructions to control the goal authoring system to generate the goal definition information described herein (e.g., the goal definition information).

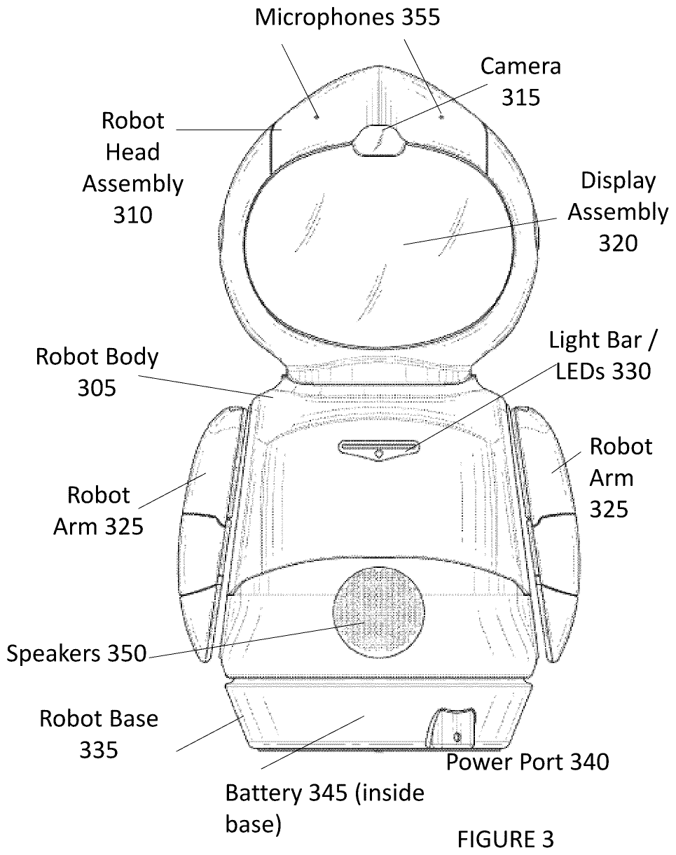

FIG. 3 illustrates a robot computing device that may be utilized for multiple users according to some implementations. In some implementations, the robot computing device or digital companion 300 may include one or more imaging devices 315, a robot body 305, a root head assembly 310, a robot base 335, a robot display assembly 320, one or more microphones 355, one or more touch sensors (not shown), one or more IMU sensors (not shown), one or more motors and/or motor controllers for controlling movement one of or more robot appendages or arms 325 (not shown), one or more power sources or batteries 345, one or more light assemblies or light bars or LEDs 330, one or more power interfaces or power ports 340 and/or one or more speakers 351. As described in detail in FIG. 2, in some implementations, the robot computing devices may include one or more processors 226A-226N, one or more memory devices 227, and/or one or more wireless communication transceivers 205. In some implementations, computer-readable instructions (reference numbers 211, 212, 213, 214, 215, 216, and 220) may be stored in the one or more memory devices 227 and may be executable by the one or more processors 226A-226N, to perform numerous actions, features and/or functions. In some implementations, the robot computing device 300 may perform analytics processing on data, parameters and/or measurements, audio files and/or image files captured and/or obtained from the components of the robot computing device listed above. FIG. 3 illustrates a front view of another robot or robot computing device according to some embodiments. In some embodiments, the robot or robot computing device 300 may include a robot body 305, a robot head assembly 310, and/or a robot base 335. In some embodiments, the power interface or power port 340 may connect to a power cord (not shown) which plugs into an external power source. In some embodiments, the external power source may provide power to the one or more rechargeable batteries 345 through the power port or interface 340.

In some implementations, the one or more touch sensors may measure if a user (child, parent or guardian) touches the robot computing device or if another object or individual comes into contact with the robot computing device. In some implementations, the one or more touch sensors may measure a force of the touch and/or dimensions of the touch to determine, for example, if it is an exploratory touch, a push away, a hug or another type of action. In some implementations, for example, the touch sensors may be located or positioned on a front and back of an appendage or a hand (hand touch sensor 353) of the robot computing device or on a stomach area (body touch sensor 354) of the robot computing device. Thus, the software and/or the touch sensors may determine if a child is shaking a hand or grabbing a hand of the robot computing device or if they are rubbing the stomach of the robot computing device. In some implementations, other touch sensors may determine if the child is hugging the robot computing device. In some implementations, the touch sensors may be utilized in conjunction with other robot computing device software where the robot computing device could tell a child to hold their left hand if they want to follow one path of a story of hold a left hand if they want to follow the other path of a story.

In some implementations, the one or more imaging devices 315 may capture images and/or video of a child, parent or guardian interacting with the robot computing device. In some implementations, the one or more imaging devices 315 may be located on a top area of a robot computing device 300 in order to capture a larger area in front of the user. In some implementations, the one or more imaging devices 315 may be located on of the display assembly or screen 320. In some implementations, the one or more imaging devices 315 may capture images and/or video of the area around the child, parent or guardian. In some implementations, the one or more microphones 355 may capture sound or verbal commands spoken by the child, parent or guardian. In some implementations, the one or more microphones 355 may be positioned or located on top of the robot computing device 300. In some implementations, computer-readable instructions executable by the processor or an audio processing device may convert the captured sounds or utterances into audio files for processing.

In some implementations, the one or more IMU sensors (not shown) may measure velocity, acceleration, orientation and/or location of different parts of the robot computing device. In some implementations, for example, the IMU sensors may determine a speed of movement of an appendage or a neck. In some implementations, for example, the IMU sensors may determine an orientation of a section or the robot computing device, for example of a neck, a head, a body or an appendage in order to identify if the hand is waving or in a rest position. In some implementations, the use of the IMU sensors may allow the robot computing device to orient its different sections in order to appear more friendly or engaging to the user.

In some implementations, the robot computing device 300 may have one or more motors (e.g., 162 or 163) and/or motor controllers. In some implementations, the computer-readable instructions may be executable by the one or more processors and commands or instructions may be communicated to the one or more motor controllers to send signals or commands to the motors to cause the motors to move sections of the robot computing device 300. In some implementations, the sections may include appendages or arms 325 of the robot computing device and/or a neck or a head 310 of the robot computing device 300.

In some implementations, the robot computing device 300 may include a display or monitor or display assembly 320. In some implementations, the monitor or display assembly 320 may allow the robot computing device 300 to display facial expressions (e.g., eyes, nose, mouth expressions) as well as to display videos, animations, or messages to the child, parent or guardian.

In some implementations, the robot computing device 300 may include one or more speakers 351, which may be referred to as an output modality. In some implementations, the one or more speakers 351 may enable or allow the robot computing device to communicate words, phrases and/or sentences and thus engage in conversations with the user. In addition, the one or more speakers 351 may emit audio sounds or music for the child, parent or guardian when they are performing actions and/or engaging with the robot computing device 300.

In exemplary embodiments, users may engage in activities with the robot computing device. These activities could include dancing along with the robot, reading a book with the robot, engaging in minor exercises at a robot's instructions, singing with the robot and/or doing breathing exercises with the robot computing device. In many cases, a user may need to select these activities and they may not specifically align with a user or child's need. Described herein is a scheduling method and system that takes into account a number of factors in order to provide a schedule of activities that may benefit the user's interacting with the robot computing device. In exemplary embodiments, the activity scheduling method and system may have users that are children, young adults, adults and/or the elderly. In other embodiments, the activity scheduling method and system may have users that are therapy or medical patients and/or students. In this paper, users may also be referred to as subjects and subjects may cover each of the categories listed immediately above.

In exemplary embodiments, the activity scheduling method and/or system may take into consideration a user or subject's prior interactions with the robot computing device, a parent's, therapist's, caregiver's, or educator's input into which activities would be most beneficial for the user and a number of other factors and utilizing these factors may generate a proposed activity schedule for the user or subject for that day or time period. The activity schedule method, apparatus, system or device described herein provides a more detailed, focused and efficient schedule of activities for a user or subject interacting with a robot computing device.

In exemplary embodiments, a robot computing device may request a cloud-generated activity schedule. In some implementations, the robot computing device may request a cloud-generated activity schedule during startup or initialization of the robot computing device. In some implementations, the robot computing device may request a cloud-generated activity schedule after coming out of being suspended or being in a sleep mode. In some implementations, the cloud computing device may generate a cloud-generated activity schedule, based at least in part, on the parameters and/or information described above, ahead of a request made by the robot computing device. In some implementations, the recommended activity schedule may be generated on the robot computing device instead of the cloud computing device. In these implementations, the operations disclosed above and below may be performed on the robot computing device alone, or by a combination of the robot computing device and the cloud computing device.

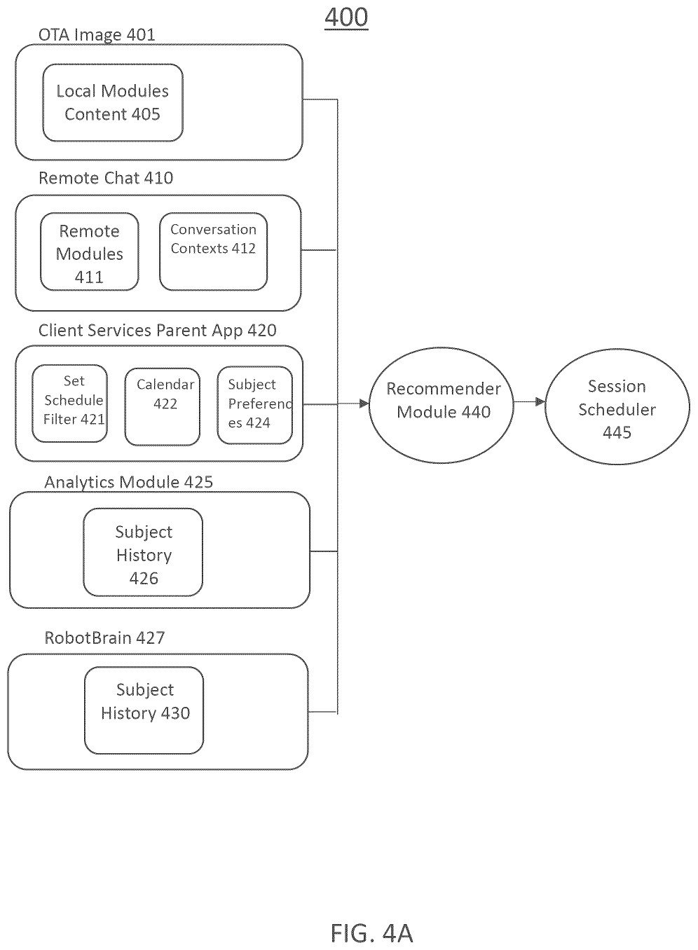

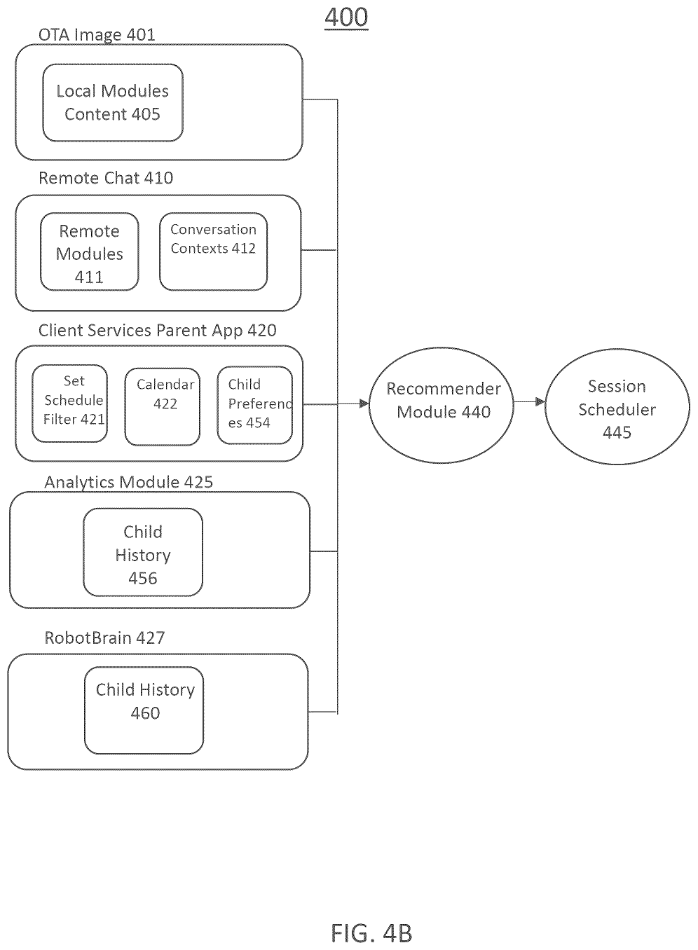

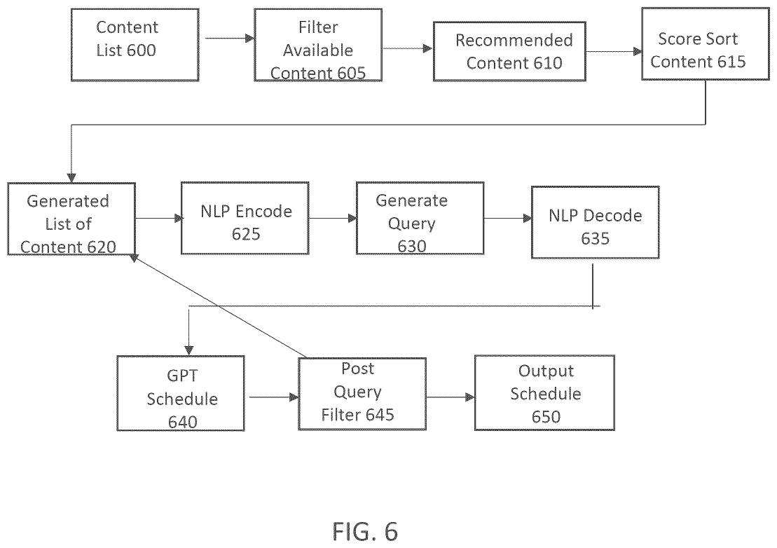

In some implementations, for example, the cloud activity content may include audio, visual video, facial expressions and movement instructions and parameters for a plurality of activities available on the cloud computing devices. In some implementations, the robot computing device may take the cloud activity content and utilize this to engage in activities. In some implementations, the robot computing device may take the cloud activity content audio, visual video, facial expressions and movement instructions and utilize this to drive the robot computing device. FIG. 4A is a block diagram of modules included in a robot computing device system that includes an automatic activity scheduling method or process for users or subjects according to exemplary embodiments. FIG. 4B is a block diagram of modules included in a robot computing device system that includes an automatic activity scheduling method or process or children according to specific embodiments. FIG. 6 is a flowchart of a process for creating and receiving an activity schedule for an individual, subject or user according to exemplary embodiments.

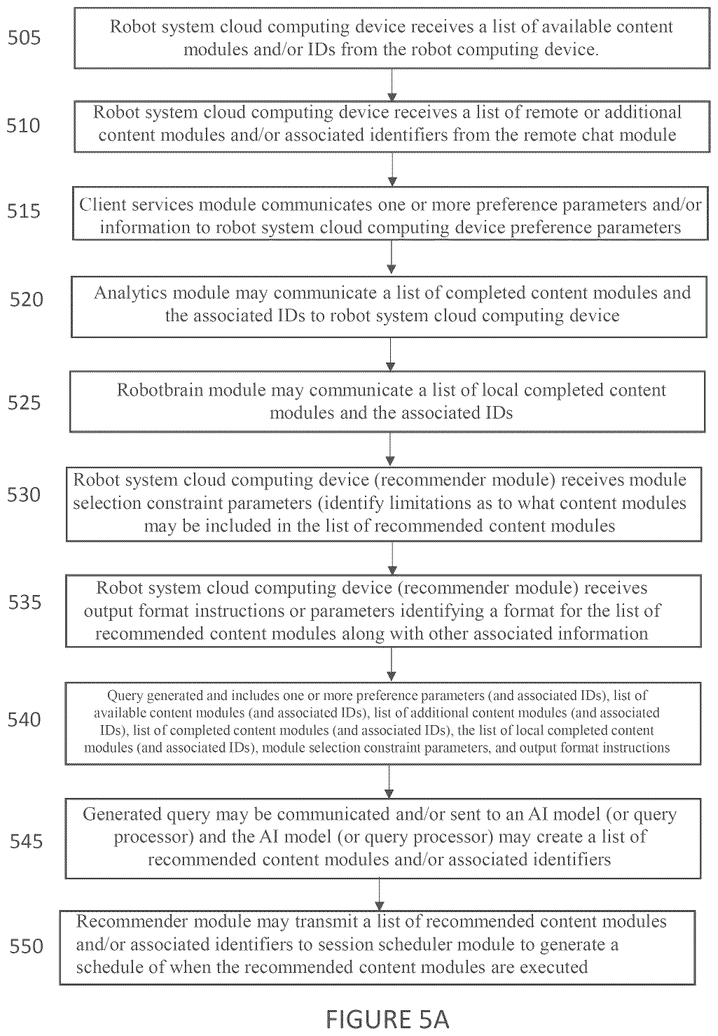

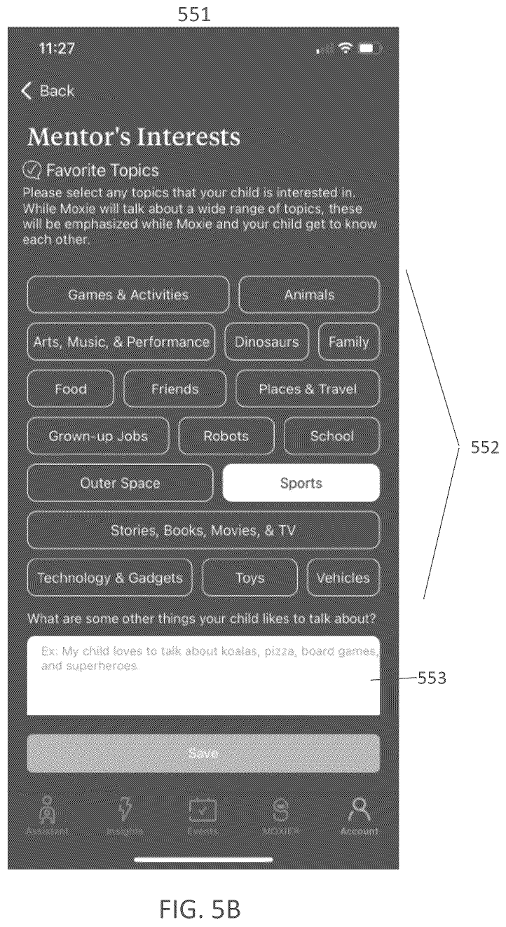

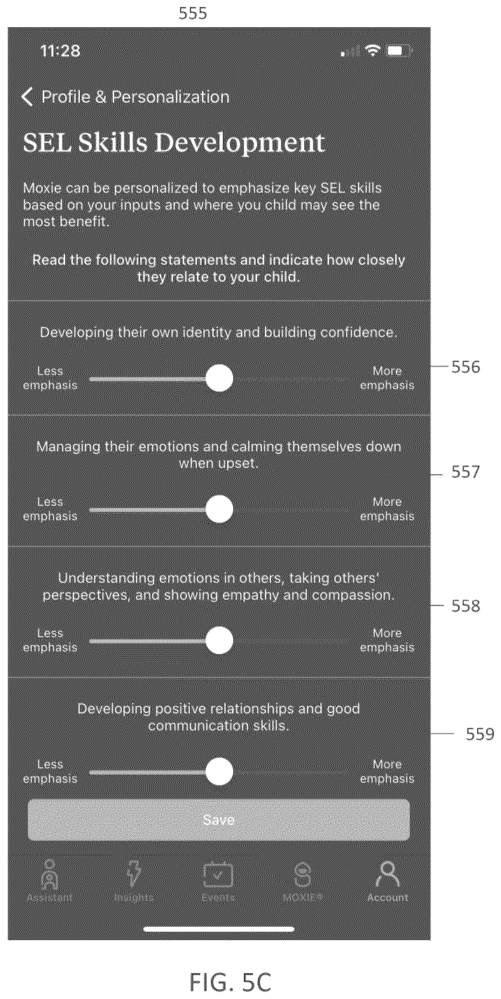

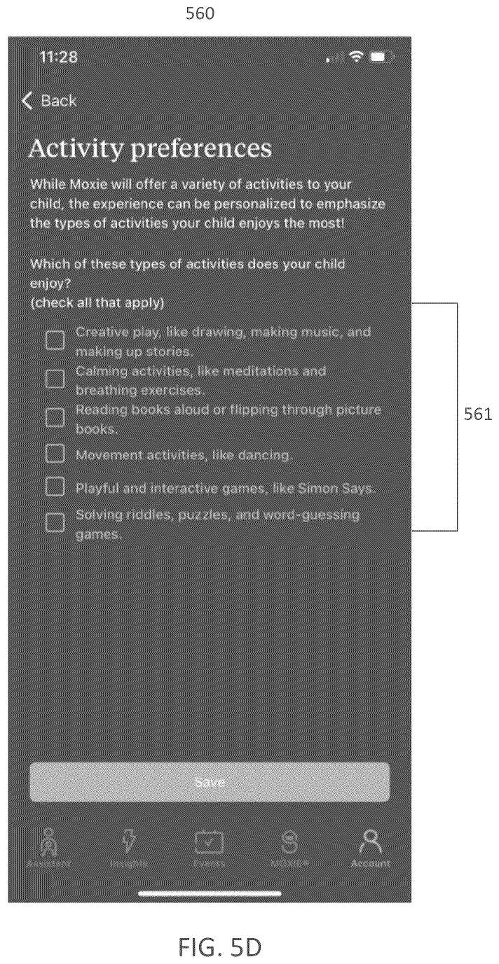

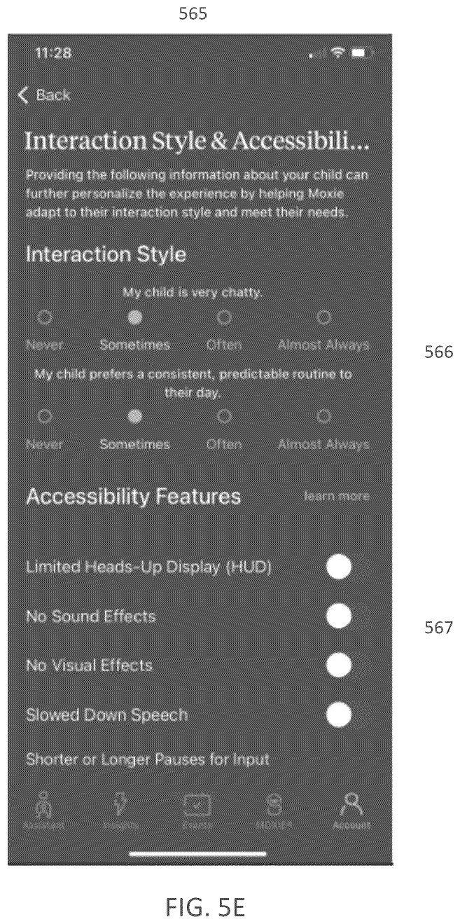

FIG. 4A is a block diagram illustrating different software modules in an automatic activity module scheduler system in a robot computing device system according to exemplary embodiments. FIG. 4B is a block diagram illustrating different software modules in an automatic activity module scheduler system for users in a robot computing device system according to exemplary embodiments. FIG. 5A is a flowchart of an automatic scheduling method or process according to exemplary embodiments. FIG. 6 is a data flow of an automatic activity scheduling method or process according to exemplary embodiments. In exemplary embodiments, some of the modules described and illustrated in FIGS. 4A and 4B may be resident on the robot computing device, whereas some of the modules may be resident on a robot system cloud computing device. In exemplary embodiments, automatic activity scheduler system 400 may include an embedded robot computing device software image 401, which is the computer-readable instructions or software that are stored in one or more memory devices of the robot computing device. The computer-readable instructions or software may be executed by one or more processors of the robot computing device. In exemplary embodiments, the embedded robot computing device software image or software 401 may be updated wirelessly or over-the-air from a robot system cloud computing device. In exemplary embodiments, the OTA software image 401 may include local content modules 405.

In exemplary embodiments, in step 505, a cloud computing device of the robot computing system may receive a list of available local content modules and/or associated identifiers (“IDs”) from the robot computing device. In some implementations, the local content module 405 may include local activity content modules (e.g., audio, visual video, facial expressions and movement instructions and parameters) that a user and the robot computing device may engage in along with the content module's identifier. As an illustrative example, the local activity content modules may include chair yoga, animal breathing, name that feeling, memory games, brain twisters, exercise, reading, dance, and scavenger hunt, lesson plan recollection, and/or therapy games. In exemplary embodiments, the local content module 405 may include a list of all content modules (e.g., available activities and/or missions) that may be installed or located within the OTA software image 401 of the robot computing device. In exemplary embodiments, the local content module 405 may be communicatively coupled to the recommender module 440. In exemplary embodiments, the local content module 405 may communicate and/or send the list of available content modules and/or associated content IDs to the recommender module 440. In exemplary embodiments, a description of the available content modules for the users or subjects may also be sent to the recommender module 440 from the OTA software image 401. In exemplary embodiments, the recommender module 440 may include computer-readable instructions stored in one or more memory devices of a cloud computing device that are executable by one or more processors of the cloud computing device.

In exemplary embodiments, the automatic activity scheduler system 400 may include a remote chat module 410. In exemplary embodiments, the remote chat module 410 may include a remote content module 411 and a conversational context module 412. In exemplary embodiments, the remote content module 411 may include a) remote content modules located and/or available on the robot system cloud computing devices (and not available on the robot OTA image 401) and/or third-party computing devices (e.g., third-party conversational modules or third-party content modules), associated identifiers (IDs) for the remote content modules, and/or b) a descriptions or summary of the remote content modules and/or third-party content modules. In exemplary embodiments, third-party conversational modules or third-party content modules may be stored on third-party computing devices. In these embodiments or implementations, the third-party content or conversational modules may be retrieved by utilizing an application programming interface (API) and then be utilized and/or communicated over the robot computing device for utilization in interactions with users. In exemplary embodiments, the conversational context module 412 may include specific modules directed to conversations between a robot computing device and a user. In exemplary embodiments, in step 510, a cloud computing device of a robot system may receive a list of remote or additional content or conversational modules and/or associated identifiers from the remote chat module 410. In exemplary embodiments, the remote chat module 410 may be communicatively coupled with the recommender module 440. In some implementations, the remote chat module 410 may include computer-readable instructions executable stored in one or more memory devices of a robot system cloud computing device and executable by one or more processors of the robot system cloud computing device. In exemplary embodiments, the remote chat module 410 may communicate the remote or additional content modules and/or associated identifiers (IDs) to the recommender module 440. As discussed previously, the remote chat module 410 may be computer-readable instructions stored on one or more memory devices in the robot computing device and executable by one or more processors of the robot computing device.

In exemplary embodiments, the automatic activity module scheduler system 400 may include a client services module 420. In exemplary embodiments, the client services module 420 may also be referred to as a client services and parent application module, because the parent application may be where preference parameters are input and/or edited. In some implementations, the parent application module may by referred to as a resource provider module where the resource provider is a caregiver, an educator, a medical professional and/or a therapist. In some implementations, the parent application may be referred to as a moxie robot module. In exemplary embodiments, the client services module 420 may include a set or established schedule filter module 421, a calendar module 422, and/or a subject preferences module 424. In some implementations, the client services module 420 may be a web or cloud software service that connects the robot computing device with parent app or moxie robot/resource provider software and the robot system cloud computing device. Thus, the client services module 420 may be computer-readable instructions stored in one or more memory devices of the robot computing device and/or robot system cloud computing devices and/or executable by one or more processors of the robot computing device and/or robot system cloud computing devices. In exemplary embodiments, an established schedule filter module 421 may include events and/or activities that are already established and in place for the user or subject of the robot computing device. In other embodiments, the schedule filter module 421 includes or excludes particular activities based on the information provided by the Parent, Moxie Robot or Resource ProviderApp (interface for the parent, caregiver, therapist, teacher, and/or educator), In other embodiments, the schedule filter module 421 enables to selection of special activities that might require special permission or subscription from the user. In some implementations, the set or established schedule filter 421 may communicate set scheduled dates and/or parameters to the recommender module 440.

In exemplary embodiments, the calendar module 422 may include different dates and/or activities that are important for the user of the robot computing devices. In some implementations, the calendar module 422 may communicate calendar dates, activities and associated parameters to the recommender module 440.

FIG. 4A illustrates a subject preferences module 424 in the client services module 420. FIG. 4B illustrates a more specific child preferences module 452 in the client services module when the robot computing system is being utilized with children. In some implementations, the robot computing device may be utilized to interact with many users or subjects, including children ages 5 to 10, young adults, adults and/or elderly individuals. In some implementations, these subjects may be students, patients, after-school participants, therapy services users. In exemplary embodiments, such as FIG. 4A, the subject preferences module 424 may include preference parameters that a resource provider or parent/guardian may establish for the user or subject for interactions with the robot computing device. In some implementations, the resource provider or parent/guardian may enter likes or dislikes of the subject, an age of the subject (if user or subject is over the age of 18), a therapeutic goal of the patient, known family members of the subject (if a user or subject is over the age of 18), games a subject likes, activities a subject likes, whether the subject is married (if the user or subject is over the age of 18), educational goals of the subject, past history of the subject (if the user or subject is over the age of 18). All of these preference parameters may be entered if the subject provides consent (or the parent or the guardian of the subject) provides consent. In exemplary embodiments, the subject preferences module 424 may include the preference parameters and/or information established by the resource provider during setup of the robot software application. In some implementations, the preference parameters and/or information may also be changeable and/or editable by the resource provider when using the parent application. FIGS. 5B-5E are directed to a child's preference module 454 but similar input screens may be available for the resource provider to enter in the preferences parameters to the subject preferences module 424. In addition, there may be open text input screens where resource providers may enter additional preference parameter information. In some implementations, as illustrated in FIG. 4B, where the subject is a child or user under the age of 18, a child preferences module 454 may be utilized. In these implementations, the child preferences module 454 may include the preference parameters and/or information established by the parent during setup of the parent or robot application. In some implementations, the preference parameters and/or information may also be changeable and/or editable by the parent or guardian when using the parent application. In some implementations, the preference parameters and/or information may be free form text that a parent or guardian has added in identifying likes or dislikes or the users or child. Examples of preference parameters and/or information may include a user's interest (e.g., games, animals, robots, stories, technology, family, travel, etc.). FIG. 5B illustrates a mentor's interests screen 551 in the parent application according to some embodiments. Reference number 552 on the mentor's interest screen identifies different mentor or user interests such as food, sports, animals, grown-up jobs, toys, etc. Reference number 553 allows a resource provider or parent to enter in free form text in the mentor's interest screen. Additional examples of preference parameters and/or information may include a user's SEL skills development level. FIG. 5C illustrates a user's SEL Skills Development Input Screen 555 according to exemplary embodiments. Examples of skill development levels include, but are not limited to: a) developing own entity and/or building confidence (as illustrated by reference number 556); b) managing their emotions (as illustrated by 557); c) understanding emotions in others, learning perspectives and showing/practicing empathy (as illustrated by reference number 558); and d) developing positive relationships and good communication skills (as illustrated by reference number 559). FIG. 5D illustrates an Activity Preferences Input Screen 560 according to exemplary embodiments. Further examples of preference parameters and/or information includes activity parameters and information. Specific examples of activity parameters and information include, but are not limited to creative play (e.g., making music, stories, drawings); calming activities (meditation or breathing exercises); reading books aloud; movement activities that enhance physical health (e.g., dancing, exercising); communication activities (creating a story, making conversation); academic activities (spelling, math operations, geometry); or playful games, or solving riddles or puzzles or word-guessing (all of which are illustrated by reference number 561). FIG. 5E illustrates an Interaction Style and Accessibility input screen 565 according to some implementations. In exemplary embodiments, preference parameters and/or information may include interaction style and/or accessibility parameters. In some implementations, the interaction style parameters may include talk-related parameters (e.g., chatty, sometimes quiet, etc.) and/or may include routine parameters (e.g., likes set or consistent routine or likes something new) (as illustrated by reference number 566). In some implementations, the accessibility parameters may include display parameters (e.g., utilize limited heads-up display), sound parameters, visual effect parameters, speech speed parameters, and/or parameters (as illustrated by reference number 567). With respect to the subject preferences module 424, the subject preferences module 424 may also include accessibility information (if the user or subject is over the age of 18), of limited visual ability, limited mobility, and/or limited memory recall ability to assist in setting up the robot computing device to engage with older or elderly patients.

In exemplary embodiments, in step 515, the client services module may communicate and/or send one or more preference parameters and/or information and the preference parameters may include topic preference parameters, activity preference parameters and/or skill preference parameters. In exemplary embodiments, the client services module 420 may be communicatively coupled to the recommender module 440. In exemplary embodiments, the client services module 420 may communicate the one or more preference parameters to the recommender module 440.

In exemplary embodiments, the subject preferences module 424 (or the child's preferences module 454) may also include scoring parameters which are collected over a time period when the subject or user is interacting with the robot computing device. As an illustrative example, if the automatic activity scheduler system provide a list of activity modules a number of times in the past, and some of the activity modules were completed by users three times, some of the activity modules were completed two times and some of the activity modules were never completed, the automatic scheduler system may generate higher scoring parameters for the activity modules completed three times and medium scoring parameters for the activity modules completed two times. In addition, the automatic activity scheduler system may analyze whether or not the completed activity modules from the recommended list of activity content modules positively impacted goals that the resource provider and/or parent had established for the subjects and/or children interacting with the robot computing device. In these implementations, the collection of these information and preference parameters may define a subject's, user's or child's profile in the subject preferences module 424 or the child's preference module 454. In this way, the recommender module 440 may balance or weigh the goals input by the resource provider or parent/guardian, the user's or subject's preference parameters and/or a history of a user's or subject's completed content activity modules versus established goals in determining which activity content modules may be selected and placed in a list of recommended activity content modules. In exemplary embodiments, the automatic activity scheduler system 400 may collect anonymized preference parameters across all subjects or users in a data repository. In exemplary embodiments, the automatic activity scheduler system 400 may collect anonymized preference parameters across similar users or subjects in a data repository (e.g., all users between ages of 5-10, or over 60 years old; all therapist users or subjects; or all educational users and/or subjects.

In exemplary embodiments, the automatic activity scheduler system 400 may include an analytics module 425 and/or a robotbrain module 427. In exemplary embodiments, as illustrated in FIG. 4A, the analytics module 425 may include a subject history module 426. In exemplary embodiments, the user or subject history module 426 may include activity modules and/or mission modules on the robot cloud computing device system that a user has previously engaged and/or completed with the robot computing device. In some implementations, the analytics module 425 may include scoring parameters and/or preference parameters from the subject preferences module 424. In exemplary embodiments, as illustrated in FIG. 4B (which illustrates an analytics module 425 in a child environment, the analytics module 425 may include a child or user history module 456. In these embodiments, the child or user history module 456 may include activity modules and/or mission modules on the robot cloud computing device system that a child has previously engaged and/or completed with the robot computing device. In some implementations, the child or user history module may include scoring parameters and/or preference parameters from the child preferences module 454. In exemplary embodiments, in step 520, the analytics module may communicate and/or send a list of completed content modules and the associated IDs to the robot system cloud computing device. Thus, the client services module 420 may be computer-readable instructions stored in one or more memory devices of the robot system cloud computing devices and/or executable by one or more processors of the robot system cloud computing devices. In exemplary embodiments, the analytics module 425 may be communicatively coupled to the recommender module 440. In exemplary embodiments, the analytics module 425 may communicate a list of completed content modules, associated IDs, and/or description of the completed content modules to the recommender module 440. In some implementations, this may be the completed content modules available on the robot system cloud computing devices. One could go even further and collect user preferences across all users in the data lake hosted by the analytics module to create fleet-wide preferences that might also be used by the recommender module.

In exemplary embodiments, the analytics module 425 may collect and/or store user, subject and/or children's preferences from subject preferences modules 424 and/or children's preferences modules 454 for a whole fleet of robot computing devices or for a large group of robot computing devices. Similarly, the analytics module 425 may collect and/or store user, subject and/or children's preferences from subject preferences modules 424 and/or children's preferences modules 454 for a specific identified group of robot computing devices (e.g., robot computing devices owned by a specific entity or all robot computing devices used by children under 18.

In exemplary embodiments, the automatic activity module scheduler system 400 may include a robotbrain module 427. In exemplary embodiments, as illustrated in FIG. 4A, the robotbrain module 427 may include a current subject or user history module 430. In exemplary embodiments, the current subject or user history module 430 may include more recent activity modules and/or mission modules that a user or subject has recently engaged with and/or completed with the robot computing device. In exemplary embodiments, as illustrated in FIG. 4B, which is directed to children, the robotbrain module 427 may include a current child history module 460. In exemplary embodiments, the current child history module 460 may include recent activity modules and/or mission modules that a child has recently engaged and/or completed with the robot computing device. In exemplary embodiments, the subject or user history module 426 and/or the subject or user history module 430 may generate a list of completed local content modules, associated identifiers and description of the local completed content modules. In exemplary embodiments more focused on children, the child history module 456 and/or child history module 460 may generate a list of completed local content modules, associated identifiers and description of the local completed content modules. In exemplary embodiments, in step 525, the robotbrain module may communicate and/or send a list of local completed content modules and the associated IDs to the robot system cloud computing device. In exemplary embodiments, the robotbrain module 427 may be communicatively coupled to the recommender module 440. Thus, the robotbrain module 427 may be computer-readable instructions stored in one or more memory devices of the robot system cloud computing devices and/or executable by one or more processors of the robot computing device. In exemplary embodiments, the robotbrain module 427 may communicate or transmit the list of completed content modules, associated identifiers and description of the local completed content modules to the recommender module 440. In some implementations, the local completed content modules may be different from completed content modules from the analytics module 425.

In exemplary embodiments, in step 530, the recommender module 440 may receive module selection constraint parameters. In some implementations, the module selection constraint parameters may identify limitations as to what content modules may be included in the list of recommended content modules. As illustrative examples, in some implementations, one module selection constraint parameter may be that a selected module (e.g., activity or mission) may not have been previously completed. An additional module selection constraint parameter may include a number of content or activity modules that may be recommended by the recommender module 440. A further module selection constraint parameter may include that one of the content modules selected may include one content modules from mission content modules. In illustrative examples, in some implementations, a further module selection constraint parameter may be that the recommended modules should include at least six (or another number) free-flow conversation (e.g., conversation contexts) modules and/or that the free-flow conversation modules may not be scheduled back-to-back.

In exemplary embodiments, in step 535, output format instructions or parameters may be received by the recommender module 440 to identify a format for the list of recommended content modules along with other associated information. As illustrative examples, in some implementations, the output format parameters may identify a type of format, (e.g., comma separated values) for the listed of recommended modules and associated parameters. Further, the output format parameters may include a summary format and/or that the user should be referred to as a mentor. Finally, in some implementations, the output format parameters may include a schedule confidence level value. In these implementations, the schedule confidence level value may include a value rating a confidence that the schedule is a good fit or match for the user.

In exemplary embodiments, in step 540, a query may be generated where the query includes one or more preference parameters (and associated IDs), the list of available content modules (and associated IDs), the list of additional content modules (and associated IDs), the list of completed content modules (and associated IDs), the list of local completed content modules (and associated IDs), the module selection constraint parameters, and the output format instructions.

In exemplary embodiments, in step 545, the generated query may be communicated and/or sent to an AI model or query processor (e.g., a Generative Pre-trained Transformer, ab Expert System, and/or a rule-based program) and the AI model or query processor may create a list of recommended content modules and/or associated identifiers based on the parameters and instructions listed in step 540. In some implementations, the list of recommended content modules and/or associated identifiers may be based, at least in part, on one or more preference parameters (and associated IDs), the list of available content modules (and associated IDs), the list of additional content modules (and associated IDs), the list of completed content modules (and associated IDs), the list of local completed content modules (and associated IDs), the module selection constraint parameters, and the output format instructions.

In exemplary embodiments, in step 550, the recommender module may transmit and/or send the list of recommended content modules and/or associated identifiers to a session scheduler module 445 to generate a schedule of when the recommended content modules are to be presented to the user in order for the user to engage the robot computing device with the recommended content modules (e.g., activities, missions, and/or discussions).

In exemplary embodiments, a query for a child user or may be structured as follows. In addition, a query for a subject or user may be structured is also described after the query for the child or user. First, a task may be defined. ###TASK####—Section of Query—Your task is to recommend the next several modules based on the descriptions in the data provided and information about the child.

In exemplary embodiments, a query may also include child profile parameters and/or information.

A child profile is then identified. The child's parent may also provide additional information and activities they are in interested in. Further, the child's parent may assign a score of 0 to 100 for how much the child's social-emotional education should emphasize a number of SEL scores. Further, the child's parent may provide additional growth information or parameters. Below is an example child profile section of a query. ###CHILD PROFILE DATA### This section of the query could include games a child is interested in, topics a child is interested in, information about the child, SEL scores for the child and/or parent or guardian free form information.

Part of a query is identifying modules that have been completed. Below is a sample a part of a query including completed modules.

###MODULE DATA#### This section of the query could include activity modules that are available and include the module identifier, a name of the module and a description of the activity module.

Part of a query could include mission data modules that are available and that have been completed. Below is a representative portion of this query.

###MISSION DATA#### This section of the query could include available mission modules and include the module identifier, a name of the module and a description of the mission module.

Part of a query could include chat module data modules that are available and/or have been completed. Below is an illustration of this part of a query.

####CHAT MODULE DATA#### This section of the query could include available chat modules and include the module identifier, a name of the module and a description of the chat module.

Part of a query could include completion history for modules. Below is an illustration of what may be included in this section of the query.

###COMPLETION HISTORY###—This section of the query can identify the modules that have been completed. The modules will be identified as follows: Type of Module, Name of Module, content description, activity status (whether completed or not).

Part of a query could include activity selection constraints for selecting modules. Below is an illustration of what may be included in this section of the query.

###ACTIVITY SELECTION CONSTRAINTS###—For example, this section of the query can identify a number of modules that should be included from mission modules, activity modules, and/or chat modules and where they should be placed temporally in the activity schedule.

Part of a query may be output format parameters. Below is an illustration of what may be included in this section of the query. ####OUTPUT FORMAT###—For example, this section of the query could identify what specific format the response should be (e.g., CSV, whether or not a summary should be included and how long it can be and how a subject or user may be addressed.

In addition, a query for a subject may include the following information. First, a task may be defined.

###TASK####—Section of Query—Your task is to recommend the next several modules for a subject or user based on the descriptions in the data provided and information about the subject or user.

In exemplary embodiments, a query may also include subject or user profile parameters and/or information.

A subject or user profile may then be identified. A resource owner or caregiver (or the user themselves) may also provide additional information and activities they are in interested in. Further, a resource owner or provider may assign a score of 0 to 100 for how much specific emotional and learning aspects of a subject or user may be important in selecting the content modules. Further, the resource owner or provider may provide additional growth information or parameters for the subject or user or even limitations of the subject or user. Below is an illustration of what may be included in this section of the query.

###SUBJECT PROFILE DATA###—This section of the query could include games or activities the subject is interested in, topics a subject is interested in, information about the subject or user, and/or free form information a resource provider or caregiver may enter into a robot software application.

Part of a query is identifying modules that have been completed. Below is an illustration of what may be included in this section of the query.

###MODULE DATA#### This section of the query could include activity modules that are available and include the module identifier, a name of the module and a description of the activity module.

Part of a query could include mission data modules that are available and that have been completed. Below is an illustration of what may be included in this section of the query.

###MISSION DATA#### This section of the query could include available mission modules and include the module identifier, a name of the module and a description of the mission module.

Part of a query could include chat module data modules that are available and/or have been completed. Below is an illustration of what may be included in this section of the query.

####CHAT MODULE DATA#### This section of the query could include available chat modules and include the module identifier, a name of the module and a description of the chat module.

Part of a query could include completion history for modules. Below is an illustration of what may be included in this section of the query.

###COMPLETION HISTORY###—This section of the query can identify the modules that have been completed. The modules will be identified as follows: Type of Module, Name of Module, content description, activity status (whether completed or not).

Part of a query could include activity selection constraints for selecting modules. Below is an illustration of what may be included in this section of the query.

###ACTIVITY SELECTION CONSTRAINTS###—For example, this section of the query can identify a number of modules that should be included from mission modules, activity modules, and/or chat modules and where they should be placed temporally in the activity schedule.

Part of a query may be output format parameters. Below is an illustration of what may be included in this section of the query. ####OUTPUT FORMAT###—For example, this section of the query could identify what specific format the response should be (e.g., CSV, whether or not a summary should be included and how long it can be and how a subject or user may be addressed.

FIG. 6 illustrates a flowchart for submitting an activity query and receiving back an activity schedule according to exemplary embodiments. In exemplary embodiments, in step 600, a potential list of activity content modules is generated or presented to the automatic activity module scheduler system. In exemplary embodiments, in step 605, the potential list of activity content modules may be filtered to generate a list of available content modules. In some implementations, the filtering of the activity content modules may eliminate modules that are currently undergoing redesign, include subject matter not appropriate for this user's schedule, modules that are too new and have not been fully tested, along with other criteria. Further illustrative examples include certain activity modules may not be available for maintenance reasons and/or because these content modules are not in line with a child's interest.

In exemplary embodiments, in step 610, a list of recommended content modules may be received from the recommender module (see FIG. 4) of the automatic activity module scheduler system taking into consideration all of the parameters discussed above with respect to FIGS. 4 and 5. In exemplary embodiments, in step 615, the recommended content modules may be scored or rated. In these embodiments, the recommended content modules may also be sorted according to score and/or rating and, in step 620 a generated list of content modules may be created by the recommender module. In exemplary embodiments, in step 625, the generated list of content modules and/or user preferences or parameters may be encoded in order to be formatted into a natural language processing (NLP) query. An example is a NLP query is discussed immediately above. In exemplary embodiments, in step 630, the NLP query may include the content modules and/or user preferences or parameters may be submitted to an AI model that may generate an initial activity schedule. In exemplary embodiments, the AI model may be GPT model or other versions of similar AI models. In some implementations, the AI model model may be housed on the robot computing device cloud computing devices. In some implementations, the AI model module may be housed on a third-party device computing device (e.g., such as OpenAI, Google, Azure). In some implementations, the AI model model may be the GPT, GPT-3, or GPT-4 model. In exemplary embodiments, the NLP query may include the content modules and/or user preferences or parameters may be submitted to an AI model and/or may be subject to structure rules that are applied to the NLP query in order to generate an initial activity schedule. In these embodiments, the structured rules (which may implemented utilizing computer-readable instructions executable by one or more processors) may be used along with the AI model in order to generate the list of recommended content modules (e.g., the initial activity schedule). In exemplary embodiments, in step 635, the initial activity schedule may be filtered by a post filter module. In exemplary embodiments, the post filtering may eliminate disallowed duplicate content modules, may discard content modules or chats after constraint parameter limits are reached, and/or may discard content or activity modules if content module category limits have been provided and have been exceed. In some implementations, the post filtering may also include decomposing the initial activity schedule into activity category contents, ordering the content or activity modules to minimize adjacent similar activity categories and to maximize a distance between such activity categories. In some implementations, the post filtering may remap the initial content module list or schedule into a new order after these post filtering has been completed to produce a final content module list. In exemplary embodiments, in step 640, after filtering, a final activity schedule or final content module list may be generated or created and output. In exemplary embodiments, time-based events may be submitted back to step 620 for processing.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample.

Additionally, or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A method to generate a list of recommended content modules for interactions between a robot computing device and a user, comprising:
one or more processors;
one or more memory devices;
computer-readable instructions, the computer-readable instructions accessed from the one or more memory device and executable by the one or more processors to:
receive an instruction or command to create a list of recommended content modules for a robot computing device to engage with a user of the robot computing device;
receive, from the robot computing device, a list of available content modules and associated identifiers (IDs),
receive a list of additional available content modules and associated identifiers (IDs);
receive one or more preference parameters, from a client services module, the one or more preference parameters include topic preference parameters, activity preference parameters, and skill preference parameters;
receive a list of completed content modules and associated identifiers (IDs) for the user that the user has engaged in with the robot computing device;
receive, from the robot computing device, a local list of completed content modules and associated identifiers that the user has engaged in with the robot computing device; and
receive module selection constraint parameters to identify limitations as to what content modules may be included in the list of recommended content modules.

2. The method of claim 1, further comprising:
receive output format instructions or parameters to identify a format for a report of the list of recommended content modules.

3. The method of claim 2, further comprising:
generating or rendering a query, the query including the one or more preference parameters, the list of available content modules and associated identifiers (IDs), the list of additional content modules and associated identifiers (IDs), the list of completed content modules and associated identifiers, the list of local completed content modules and associated identifiers, the module selection constraint parameters and the output format instructions or parameters.

4. The method of claim 3, further comprising:
transmitting the generated query to a AI model, the AI model to create the list of recommended content modules and associated identifiers based at least in part on the one or more preference parameters, the list of additional content modules and associated identifiers (IDs), the list of additional content modules and associated identifiers (IDs), the list of completed content modules and associated identifiers, the list of local completed activity modules and associated identifiers, the module selection constraint parameters and the output format instructions or parameters.

5. The method of claim 4, further comprising filtering the created list of recommended content modules and associated identifiers based on filtering parameters, the filtering parameters identifying modules and content that are only appropriate for testing or that have negative content tags or property tags.

6. The method of claim 4, further comprising communicating, sending or transmitting the filtered recommended content modules and associated identifiers to a session scheduler module to generate a schedule of when the recommended content modules are to be engaged in between the robot computing device and the user.

7. The method of claim 1, further comprising filtering the query based on filtering parameters before transmitting the query to the AI module, the filtering parameters identifying modules and content that are only appropriate for testing or that have negative content tags or property tags.

8. The method of claim 1, wherein the one or more preference parameters further topic preference parameters with respect to what topics the user likes to engage in with the robot computing device.

9. The method of claim 1, wherein the module selection constraint parameters include a number of content modules to be included in the list of recommended content modules.

10. The method of claim 1, wherein the module selection constraint parameters include counts by category content that identifies a numerical limit for types or categories of content that may be included in the created list of recommended content modules and associated identifiers.

11. The method of claim 10, wherein the module selection constraint parameters further includes parameters identifying that similar types of content modules should not be scheduled adjacent to other similar types of content modules.

12. The method of claim 1, wherein the module selection constraint parameters include content module types that should be included in the list of recommended content modules.

13. The method of claim 2, wherein the output format instruction or parameters include summary instructions to identify limitations on how a schedule of content is to be presented to the user.

14. The method of claim 1, wherein the output format instructions or parameters include confidence instructions to identify whether the recommended list of content modules and schedule is a good fit for the user of the robot computing device.

15. An activity recommendation system, comprising:
a recommendation module to receive an instruction or command to create a list of recommended content modules for a robot computing device to engage with a user of the robot computing device;
an over-the-air image module to communicate a list of available content modules and associated identifiers (IDs) to the recommendation module;
a remote chat module to communicate a list of additional available content modules and associated identifiers (IDs) to the recommendation module;
a client services module to communicate receive one or more preference parameters to the recommendation module, the one or more preference parameters include topic preference parameters, activity preference parameters, and skill preference parameters and communicate module selection constraint parameters to identify limitations as to what content modules may be included in the list of recommended content modules; and
an analytics module and a robotbrain module to communicate a list of completed content modules and associated identifiers (IDs) for the user that the user has engaged in with the robot computing device.

16. The recommendation system of claim 15, further comprising:
the recommendation module to receive output format instructions or parameters to identify a format for a report of the list of recommended content modules.

17. The recommendation system of claim 16, further comprising:
the recommendation module to generate or render a query, the query including the one or more preference parameters, the list of available content modules and associated identifiers (IDs), the list of additional content modules and associated identifiers (IDs), the list of completed content modules and associated identifiers, the list of local completed content modules and associated identifiers, the module selection constraint parameters and the output format instructions or parameters.

18. The recommendation system of claim 17, further comprising:
the recommendation module to transmit the generated query to an artificial intelligence (AI) model, the AI model to create the list of recommended content modules and associated identifiers based at least in part on the one or more preference parameters, the list of additional content modules and associated identifiers (IDs), the list of additional content modules and associated identifiers (IDs), the list of completed content modules and associated identifiers, the list of local completed activity modules and associated identifiers, the module selection constraint parameters and the output format instructions or parameters, wherein the AI model communicates the list of recommendation content modules and associated identifiers to a filtering module.

19. The recommendation system of claim 18, wherein the filtering module filters the created list of recommended content modules and associated identifiers based on filtering parameters, the filtering parameters identifying modules and content that are only appropriate for testing or that have negative content tags or property tags.

20. The method of claim 19, further comprising.
the filtering module to communicate or send the filtered recommended content modules and associated identifiers to a session scheduler module to generate a schedule of when the recommended content modules are to be engaged in between the robot computing device and the user.
